(19) United States
(12) Patent Application Publication
(10) Pub. No.: US 2024/0273467 A1
(43) Pub. Date: Aug. 15, 2024

(54) PROCUREMENT MANAGEMENT SYSTEM, PROCUREMENT MANAGEMENT SYSTEM COMPUTER PROGRAM, AND PROCUREMENT MANAGEMENT SYSTEM CONTROL METHOD

(71) Applicant: MISUMI Group Inc., Tokyo (JP)

(72) Inventors: Yusuke KIDO, Tokyo (JP); Yoshinori TAKASHIMA, Tokyo (JP); Yuichi KAWAI, Tokyo (JP)

(73) Assignee: MISUMI Group Inc., Tokyo (JP)

(21) Appl. No.: 18/690,093

(22) PCT Filed: Nov. 9, 2021
(86) PCT No.: PCT/JP2021/041195

§ 371 Date: Mar. 7, 2024

(30) Foreign Application Priority Data
Oct. 29, 2021 (JP) 2021-177837

(51) Int. Cl. G06Q 10/0631; G06Q 10/083

(52) U.S. Cl. CPC G06Q 10/06315; G06Q 10/083

(57) ABSTRACT

A procurement management system 100 includes: an acquisition unit 23A that acquires a request condition including a request quantity of an article requested by a user and a supply condition including a supply quantity of the article by each of a plurality of suppliers that can supply the article; a determination unit 23G that determines whether or not a distribution condition for distributing the request quantity of the article between two or more suppliers among the plurality of suppliers is satisfied based on the request condition and the supply condition; a selection unit 23B that selects two or more suppliers from among the plurality of suppliers as a supplying supplier group when the distribution condition is satisfied; and a distribution unit 23C that distributes the request quantity among the supplying supplier group.

### CROSS-REFERENCE TO RELATED PATENT APPLICATIONS

This application is a U.S. National Phase Application under 35 U.S.C. § 371 of International Patent Application No. PCT/JP2021/041195 filed on Nov. 9, 2021, which claims the benefit of priority to Japanese Patent Application No. 2021-177837 filed on Oct. 29, 2021, the contents of all of which are incorporated herein by reference in their entireties. The International Application was published in Japanese on May 4, 2023 as International Publication No. WO2023/074004 under PCT Article 21 (2).

### FIELD OF THE INVENTION

The present invention relates to a procurement management system that selects two or more suppliers from among a plurality of suppliers as a supplying supplier group, a procurement management system computer program, and a procurement management system control method.

### BACKGROUND OF THE INVENTION

As a technique related to procurement, for example, JP2014-503924A discloses a procurement network in which a seller pools its inventory together with other sellers that use the same procurement network. Specifically, the seller requests at least a part of an inventory of an article to be pooled into a common inventory pool. When the article is determined to be of the same type or quality as the same article pooled by other sellers, the seller's inventory is pooled into the common inventory pool. Then, an inventory credit is provided for the seller of the pooled inventory.

In addition, JP2021-5186A discloses a supply chain design plan generation part that generates a design plan of a supply chain of a predetermined item. Specifically, the supply chain design plan generation part extracts a record corresponding to an item to be produced or procured. Then, the supply chain design plan generation part extracts a plurality of factories and a plurality of procurement sources corresponding to the record. Then, the supply chain design plan generation part generates a supply chain design plan with a plurality of patterns including the extracted factories and a supply chain design plan with a plurality of patterns including the extracted procurement sources. Furthermore, the supply chain design plan generation part evaluates whether or not the delivery time of the generated supply chain design plan can be met, and excludes a design plan that cannot meet the delivery time from the supply chain design plan.

### CITATION LIST

### Patent Literature

Patent Literature 1: JP2014-503924A

Patent Literature 2: JP2021-5186A

### Technical Problem

A user may wish to purchase a quantity of articles exceeding the supply quantity of articles that can be supplied by one supplier. In this case, when the user orders the quantity of articles exceeding the supply quantity, the period from the order to the delivery of the articles is prolonged. That is, the supplier needs a time exceeding a normal delivery time to supply the quantity of articles exceeding the supply quantity.

### SUMMARY OF THE INVENTION

### Solution to Problem

A procurement management system according to an aspect of the present invention comprises: an acquisition unit that acquires a request condition including a request quantity of an article requested by a user and a supply condition including a supply quantity of the article by each of a plurality of suppliers that can supply the article; a determination unit that determines whether or not a distribution condition for distributing the request quantity of the article between two or more suppliers among the plurality of suppliers is satisfied based on the request condition and the supply condition; a selection unit that selects two or more suppliers from among the plurality of suppliers as a supplying supplier group when the distribution condition is satisfied; and a distribution unit that distributes the request quantity among the supplying supplier group.

In addition, a procurement management system computer program according to another aspect of the present invention is a computer program of a procurement management system comprising a computer and causes the computer to function as: an acquisition unit that acquires a request condition including a request quantity of an article requested by a user and a supply condition including a supply quantity of the article by each of a plurality of suppliers that can supply the article; a determination unit that determines whether or not a distribution condition for distributing the request quantity of the article between two or more suppliers among the plurality of suppliers is satisfied based on the request condition and the supply condition; a selection unit that selects two or more suppliers from among the plurality of suppliers as a supplying supplier group when the distribution condition is satisfied; and a distribution unit that distributes the request quantity among the supplying supplier group.

Furthermore, a procurement management system control method according to another aspect of the present invention comprises: acquiring a request condition including a request quantity of an article requested by a user and a supply condition including a supply quantity of the article by each of a plurality of suppliers that can supply the article; determining whether or not a distribution condition for distributing the request quantity of the article between two or more suppliers among the plurality of suppliers is satisfied based on the request condition and the supply condition; selecting two or more suppliers from among the plurality of suppliers as a supplying supplier group when the distribution condition is satisfied; and distributing the request quantity among the supplying supplier group.

### Advantageous Effects of Invention

Thus, by distributing the quantity of the article requested by the user among the plurality of sub-suppliers, the period from a purchase order to the delivery of the article can be shortened.

### BRIEF DESCRIPTION OF THE DRAWINGS

FIG. 1 is a schematic configuration diagram of an entire sales management system.

FIG. 2 is an explanatory diagram of an outline of procurement management according to a first embodiment.

FIG. 3 is a schematic block diagram of the sales management system.

FIG. 4 is a schematic diagram illustrating an example of an article screen.

FIG. 5 is a schematic diagram illustrating an example of a detail screen.

FIG. 6 is a schematic diagram illustrating an example of an order confirmation screen.

FIG. 7 is a schematic diagram illustrating an example of a batch shipping screen.

FIG. 8 is a flowchart of distribution processing.

FIG. 9 is an explanatory diagram of an outline of procurement management according to a second embodiment.

FIG. 10 is a schematic diagram illustrating another example of the article screen.

### DETAILED DESCRIPTION OF THE INVENTION

Hereinafter, exemplary embodiments for carrying out the present invention will be described in detail with reference to the drawings. However, the dimensions, materials, shapes and relative positions of the components described in the following embodiments can be arbitrary set and can be changed according to the configuration of an apparatus to which the present invention is applied or to various conditions. Unless otherwise specified, the scope of the present invention is not limited to the embodiments specifically described below.

### [First Embodiment]

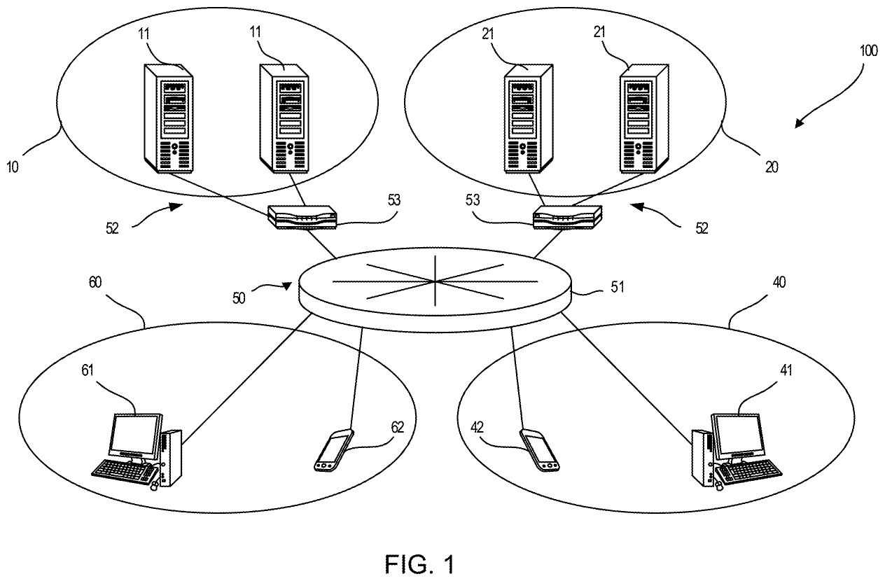

FIG. 1 illustrates a sales management system 100 including a procurement management system that selects two or more suppliers from among a plurality of suppliers as a supplying supplier group. As an example, the suppler is a supplying company that produces, processes, sells, transports, or stores an article to supply the article. In addition, one supplying company may act as a plurality of suppliers and own a plurality of storage warehouses, production bases, and the like of the article. In the sales management system 100, there are a user terminal 40 managed by a user, an inventory management server 10 and a procurement management server 20 managed by a management company such as a seller, and a supplier terminal 60 managed by the supplier. For example, the user purchases the article serving as a product from the seller. Then, the seller procures the product from the supplier and sells the product to the user. In addition, the supplier supplies the product to the seller.

The sales management system 100 is configured as a network system or a client server system including a procurement management system including the procurement management server 20 and the inventory management server 10. For example, the seller manages the inventory management server 10 and the procurement management server 20, and sells the product in response to a request from the user. The procurement management server 20 functions as a server device, and is configured as one logical server device when, for example, server units 21 are combined as a plurality of computers. In addition, the inventory management server 10 also functions as a server device, and is configured as one logical server device when, for example, server units 11 are combined as a plurality of computers. However, the procurement management server 20 may be configured by a single server unit 21, or the inventory management server 10 may be configured by a single server unit 11. Alternatively, the procurement management server 20 and the inventory management server 10 may be logically configured using cloud computing.

The procurement management server 20 provides the user terminal 40 or the user of the user terminal 40 with various services including an article order service. The order service includes a distribution service that distributes a program or data to the user terminal 40 via a network 50 and a storage service that stores data received from the user terminal 40. The distribution service is, for example, a service that distributes data for update.

The inventory management server 10, which is an example of the supply quantity management server, stores and manages a supply condition including the supply quantity of the article. For example, the inventory management server 10 receives the inventory quantity of each article at each of the plurality of suppliers from the supplier terminal 60 as the supply quantity, which is an example of the supply condition. In addition, the inventory management server 10 receives from the supplier terminal 60 the supply time during which each of the plurality of suppliers supplies the article as another example of the supply condition. Then, the inventory management server 10 stores the inventory quantity of each article in association with supplier identification information for identifying each supplier. In addition, the inventory management server 10 may store and manage the supply condition including the supply quantity of the article stored by the seller. Incidentally, the article itself may be a finished product having one integrated function, or may be one article incorporated into a finished product or an assembly including a plurality of components. Furthermore, the article includes a unit, a jig, a device, and equipment in which a plurality of components are combined.

For example, the supply time is a ship date of the article, an arrival date when the article reaches the user, a production completion date of the article, a processing completion date of the article, an arrival date when the article reaches a physical distribution base, and the like. The supply time is a specific date or time, but the supply time may be information that can specify the supply timing of the article, and may be a length of time required for shipping, arrival, or completion, or a length of time required for transportation. In addition, the supply quantity is a quantity of articles that can be supplied to the user, and may be a production quantity, a processing quantity, or a shipping quantity of the supplier in a predetermined supply time. Furthermore, both the supply time and the supply quantity may be calculated or predicted by the inventory management server 10.

The user of the supplier terminal 60 transmits the supply condition to the inventory management server 10 using a means such as an e-mail at an arbitrary timing (for example, at a predetermined time, once a day, once a week, or four times a day). Alternatively, the supplier terminal 60 may automatically transmit the supply condition at a predetermined timing. In addition, the supplier terminal 60 may transmit the supply condition in response to a request from the inventory management server 10. For example, when the user inputs the request quantity of the article, the inventory management server 10 requests the supplier terminal 60 to transmit the supply condition in response to the input. Furthermore, the administrator of the inventory management server 10 may obtain the supply condition from each supplier using a means such as a telephone or a facsimile. In this case, the administrator may manually input the obtained supply condition to the inventory management server 10. Furthermore, the inventory management server 10 may acquire the supply condition from an external database, for example, an inventory quantity database. In addition, the inventory management server 10 may calculate or predict the supply condition.

The supply condition is required to include the quantity of articles that can be supplied within a predetermined period such as the inventory quantity, and the quantity may be zero or may be a quantity of articles that can be produced within the predetermined period. In addition, the supply condition may include information such as a name, model number, place of a transportation source, suppliable timing, unit price, transportation cost, specification, manufacturing condition, or processing condition as the information related to the article. Furthermore, the supply condition may include information such as the name of the supplier, supplier identification information, and location. Hereinafter, a case where the supply condition is the inventory quantity will be mainly described.

The user terminal 40 and the supplier terminal 60 are computer devices capable of network connection. For example, the user terminal 40 includes a stationary or book type personal computer 41, a portable tablet terminal device 42, and the like. In addition, the supplier terminal 60 also includes a stationary or book type personal computer 61, a portable tablet terminal device 62, and the like. The user terminal 40 and the supplier terminal 60 further include a mobile terminal device such as a portable phone (including a smartphone). The user terminal 40 and the supplier terminal 60 can cause the user to enjoy various services provided by the procurement management server 20 by implementing various types of computer programs. In addition, the supplier terminal 60 may be able to cause the supplier to enjoy various services provided by the inventory management server 10 by implementing various types of computer programs.

In addition, the user terminal 40 and the supplier terminal 60 can be connected to the procurement management server 20 via the predetermined network 50. Furthermore, the supplier terminal 60 can be connected to the procurement management server 20 and the inventory management server 10 via the predetermined network 50. Hereinafter, a case where the user terminal 40 is the personal computer 41 and the supplier terminal 60 is the personal computer 61 will be described.

The network 50 is configured such that the user terminal 40 and the supplier terminal 60 each can be connected to the procurement management server 20, and the supplier terminal 60 can be connected to the inventory management server 10. The network 50 is configured to realize network communication by using a TCP/IP protocol. Specifically, a local area network (LAN) 52 connects the procurement management server 20 and the inventory management server 10 to the Internet 51. The Internet 51 as a wide area network (WAN) is connected to the LAN 52 via a router 53. Furthermore, the network 50 may be any of a dedicated line, a telephone line, an in-enterprise network, a mobile communication network, other communication lines, combinations thereof, and the like, and may be wired or wireless. The user terminal 40 and the supplier terminal 60 are also configured to be connected to the Internet 51. Alternatively, the server unit 21 of the procurement management server 20 and the server unit 11 of the inventory management server 10 may be connected to each other by the Internet 51 instead of or in addition to the LAN 52.

The procurement management server 20 functions as a web server that causes various web pages to be displayed on a display part of the user terminal 40 in response to access from the user terminal 40. In addition, the procurement management server 20 executes processing such as arrangement of the ordered article, a transportation instruction, and billing of the purchase price in response to the order placed by the user.

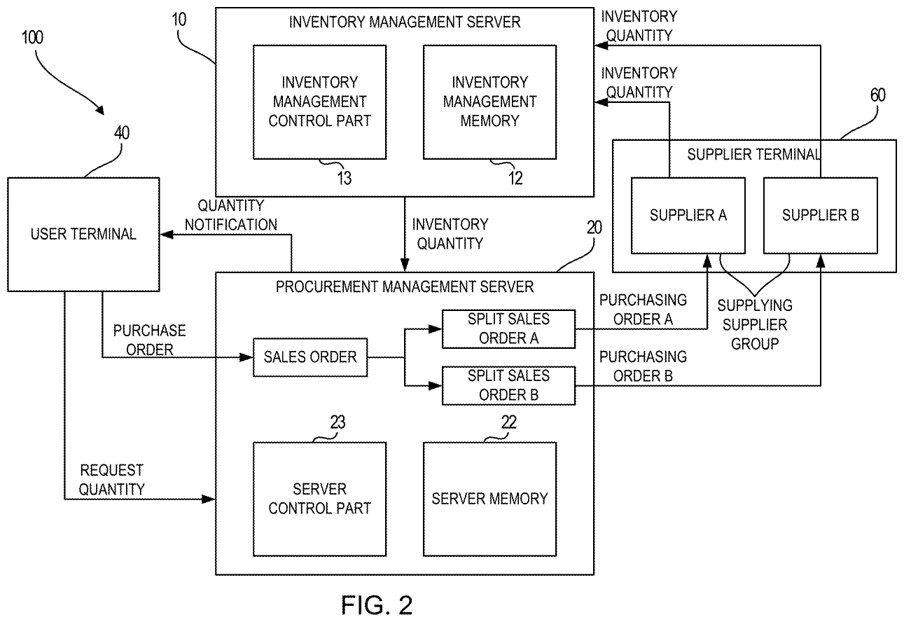

Specifically, procurement management in the sales management system 100 will be described with reference to FIG. 2. The supplier terminal 60 includes a terminal of each of the plurality of suppliers, and includes a terminal of a supplier A and a terminal of a supplier B in the example of FIG. 2. Each of the supplier terminals 60 transmits the supply condition including the inventory quantity to the inventory management server 10 at an arbitrary timing. Then, an inventory management control part 13 stores the received inventory quantity in an inventory management memory 12 in association with each supplier identification information for each article.

The user who wishes to purchase the article accesses a website provided by the procurement management server 20 from the user terminal 40. Then, the user inputs the request quantity of the article as an example of a request condition via the website. In addition, the user further inputs a delivery time of the article requested by the user as another example of the request condition. Incidentally, the request condition may include information such as the name, the model number, the place of a transportation destination, a desired price, the specification, the manufacturing condition, the processing condition, or a drawing as the information related to the article. Alternatively, the request condition may be included in a purchase order requesting for purchase of the article. In this case, when the user performs an operation of placing the purchase order, the request condition is transmitted from the user terminal 40 to the procurement management server 20. In addition, the request condition may be included in a quotation request for requesting a quotation of at least one of the price and the delivery time of the article. In this case, when the user performs an operation of requesting the quotation, the request condition is transmitted from the user terminal 40 to the procurement management server 20. As an example, the delivery time is information indicating the reference timing for the receipt timing of the article, such as a shipping timing, arrival timing, or production completion timing of the article.

A server control part 23 of the procurement management server 20 acquires the input request condition and stores the acquired request condition in a server memory 22 of the procurement management server 20. Furthermore, the server control part 23 acquires the inventory quantity from the inventory management server 10, and selects a supplier that can supply the requested article. Here, when the inventory quantity of one specific supplier is equal to or larger than the request quantity, the server control part 23 selects the specific supplier. Then, the server control part 23 notifies the user, that the purchase order is possible, by reporting the quantity to be purchased by the user. The user checks the quantity and performs the operation of placing the purchase order. Alternatively, the server control part 23 may notify the user, that the purchase order is possible, by enabling the operation of placing the purchase order such as displaying a predetermined button. For example, the purchase order includes information indicating a model number for identifying the article, a desired delivery time of the article, the quantity of articles, and the transportation destination of the article. In addition, when the article procured from the specific supplier is stored by the purchasing company and the inventory quantity is equal to or larger than the request quantity, the server control part 23 may notify the user that the purchase order is possible. For example, the seller may sell the article procured from the supplier and stored by the seller itself to the user.

Subsequently, the server control part 23 receives the purchase order and creates a sales order corresponding to the received purchase order. Furthermore, the server control part 23 creates the purchasing order associated with sales identification information for identifying the sales order (for example, a sales order number and the like). Then, the server control part 23 transmits the purchasing order to the supplier terminal 60 of the specific supplier. For example, the purchasing order includes information indicating a model number for identifying the article, the shipping timing of the article, the quantity of articles, and the transportation destination of the article. Then, the specific supplier supplies the quantity of articles corresponding to the purchasing order.

On the other hand, when the inventory quantity of one supplier is smaller than the request quantity, the server control part 23 selects two or more suppliers that can supply the article from among the plurality of suppliers as the supplying supplier group. At this time, the server control part 23 selects the supplying supplier group such that the total inventory quantity of the supplying supplier group is equal to or larger than the request quantity. Then, the server control part 23 distributes the request quantity of the article among the supplying supplier group. For example, when the request quantity is 50, the server control part 23 distributes 24 pieces to the supplier A and 26 pieces to the supplier B.

In the example of FIG. 2, the supplying supplier group is formed of the supplier A and the supplier B. However, the supplying supplier group may be formed of three or more suppliers. Furthermore, the server control part 23 notifies the user, that the purchase order is possible, by reporting the quantity to be purchased by the user. The user checks the quantity and performs the operation of placing the purchase order. Subsequently, the server control part 23 receives the purchase order and creates a sales order corresponding to the received purchase order. Furthermore, the server control part 23 creates a split sales order as a plurality of sales orders associated with basic sales identification information for identifying the sales order (for example, the sales order number and the like) . The plurality of split sales orders are associated with split sales order identification information for identifying each of the plurality of split sales orders (for example, the sales order number with a branch number, and the like).

In the example of FIG. 2, the server control part 23 creates a split sales order A and a split sales order B as the plurality of sales orders. The split sales order A is a sales order to the supplier A, and the split sales order B is a sales order to the supplier B. For example, if the request quantity is 50, the split sales order A includes a quantity of 24 as the quantity of articles to be ordered to the supplier A, and the split sales order B includes a quantity of 26 as the quantity of articles to be ordered to the supplier B. Then, the server control part 23 creates a plurality of purchasing orders corresponding to the plurality of split sales orders, and transmits the purchasing order to the supplier terminal 60 of each supplier. In the example of FIG. 2, the server control part 23 creates a purchasing order A and a purchasing order B as the plurality of purchasing orders.

Then, the supplier that has received the purchasing order supplies the article corresponding to the purchasing order. For example, the supplier ships the article specified by the model number to the transportation destination specified by the purchasing order in the quantity and the shipping timing specified by the purchasing order. Incidentally, when the total inventory quantity of the plurality of suppliers is smaller than the request quantity, the server control part 23 may notify the user of that effect. In addition, the notification may include a proposal for changing the desired delivery time or request quantity.

### [Control System]

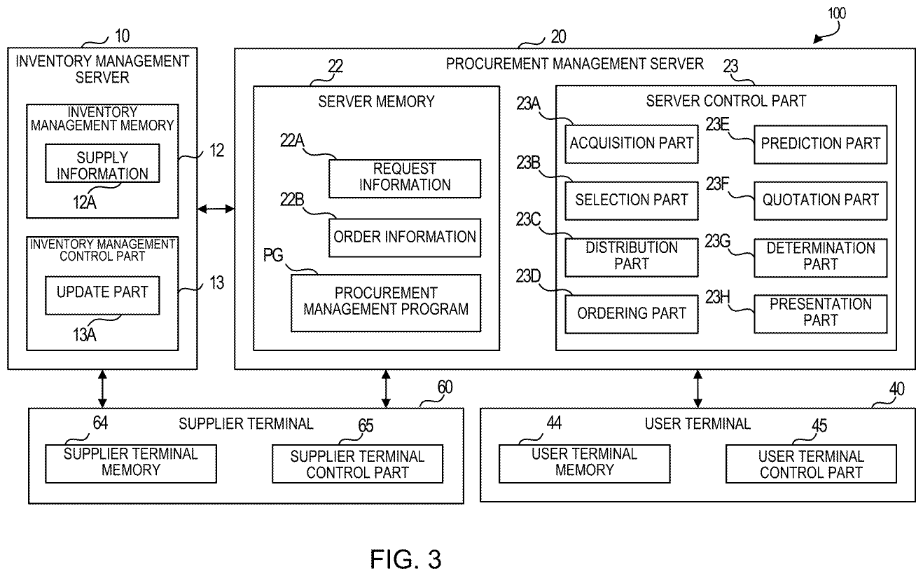

Next, a schematic configuration of a control system of the sales management system 100 will be described with reference to FIG. 3. The procurement management server 20, which is an example of the procurement management unit, includes the server control part 23 as a control unit of the procurement management server 20, and the server memory 22 as a non-transitory computer-readable storage medium. In addition, the inventory management server 10, which is an example of the inventory management unit, includes the inventory management control part 13 as a control unit of the inventory management server 10 and the inventory management memory 12 as a non-transitory computer-readable storage medium.

The server control part 23 and the inventory management control part 13 are configured as a computer in which a processor that executes various arithmetic processes and operation control according to a predetermined program, an internal memory necessary for the operation of the processor, and other peripheral devices are combined. The processor is, for example, a central processing unit (CPU) or a micro-processing unit (MPU), and controls the entire server device based on a program stored in the server memory 22 or the inventory management memory 12 and also controls various processes in an integrated manner. Incidentally, the server control part 23 and the inventory management control part 13 can also perform control according to a program stored in a portable recording medium such as a CD, a DVD, a CF card, and a USB memory, or an external storage medium such as a cloud server on the Internet.

The server memory 22 and the inventory management memory 12 include random access memory (RAM) that is a system work memory for the processor to operate, and a storage device such as a read only memory (ROM), a hard disc drive (HDD), and a solid state drive (SSD) that store a program and system software. However, the server memory 22 is not limited to the example of being provided as a part of the procurement management server 20, and may be provided as a database server that cooperates with the procurement management server 20. Similarly, the inventory management memory 12 is not limited to the example of being provided as a part of the inventory management server 10, and may be provided as a database server that cooperates with the inventory management server 10. In the following description, the CPU executes processing operations such as various calculations, controls, and determinations according to the control program stored in the ROM or the HDD.

### [Inventory Management Unit]

The inventory management memory 12 as an example of a storage unit that stores the supply condition stores supply information 12A indicating the supply condition of each supplier. As an example, the supply information 12A includes information for specifying the article that can be provided by the supplier (for example, the model number of the article) and the quantity of the article (for example, inventory quantity). Then, the inventory management memory 12 stores the quantity in association with the supplier identification information for each article. The supply condition may be directly transmitted by each supplier or may be input by the administrator of the inventory management server 10. In addition, the inventory management memory 12 stores an inventory management program (not illustrated).

Based on the inventory management program, the inventory management control part 13 acquires the supply condition and stores the supply condition in the inventory management memory 12 in association with the supplier identification information. For this purpose, the inventory management control part 13 includes an update part 13A as an example of an update unit that acquires information from the plurality of suppliers and updates the supply condition stored in the inventory management memory 12.

The update part 13A is a logical device realized by a combination of computer hardware and software. The inventory management program stored by the inventory management memory 12 causes the inventory management control part 13 serving as a computer to function as the update part 13A. Incidentally, the update part 13A may store a quantity smaller than the received inventory quantity in the inventory management memory 12 as the inventory quantity of the supplier. This can prevent the delivery of the article from being delayed due to the shortage of the inventory quantity after the purchase order is received from the user. Furthermore, the update part 13A may store a quantity larger than the received inventory quantity in the inventory management memory 12 as the inventory quantity of the supplier. For example, the update part 13A may store the quantity of articles to which the predicted increased quantity of the inventory quantity predicted by a prediction part 23E is added in the inventory management memory 12 as the inventory quantity of the supplier.

As an example, the update part 13A periodically or in real time receives and acquires the supply condition transmitted by the supplier. Then, the update part 13A updates the supply condition stored in the inventory management memory 12 to the latest supply condition based on the acquired supply condition. Alternatively, the update part 13A may acquire information irregularly (for example, arbitrary timing when the supplier transmits the supply condition) and update the supply condition. Furthermore, the update part 13A may acquire the latest supply condition stored in an arbitrary storage unit and update the supply condition stored in the inventory management memory 12. In this case, the update part 13A may acquire information and update the supply condition periodically (for example, a predetermined time of day). Furthermore, the update part 13A may automatically acquire the supply condition, and for example, the update part 13A may request the supplier terminal 60 to transmit the supply condition.

In addition, the update part 13A may update the supply quantity in a mode combining the request quantity and the unit input by the user. For example, it is assumed that the request quantity input by the user is the number of pieces, and the supply quantity transmitted from the supplier is represented in units of dozens where 12 pieces form one set. In this case, the update part 13A converts the unit of the supply quantity into the number of pieces and replaces the stored supply quantity with the converted quantity. In addition, also when the supply quantity is indicated in units of packs where six pieces form one set, units of pairs where two pieces form one set, or a unit of size, weight, or the like, the update part 13A converts the unit of the supply quantity into the same unit as that of the request quantity. Furthermore, when the user inputs the request quantity in units such as dozens where 12 pieces form one set, the update part 13A may convert the number of pieces of the supply quantity into a unit such as dozen.

### [Procurement Management Unit]

The server control part 23 includes an acquisition part 23A, a selection part 23B, a distribution part 23C, an ordering part 23D, the prediction part 23E, a quotation part 23F, a determination part 23G, and a presentation part 23H as logical devices realized by a combination of computer hardware and software. Then, a procurement management program PG stored by the server memory 22 causes the server control part 23 serving as a computer to function as the acquisition part 23A, which is an example of an acquisition unit, the selection part 23B, which is an example of a selection unit, the distribution part 23C, which is an example of a distribution unit, the ordering part 23D, which is an example of the ordering unit, the prediction part 23E, which is an example of a prediction unit, the quotation part 23F, which is an example of a quotation unit, the determination part 23G, which is an example of a determination unit, and the presentation part 23H, which is an example of a presentation unit. Incidentally, the server control part 23 has, in addition to the logical devices described above, a logical device (not illustrated) or the like that controls switching display of a web page and the like according to an operation of the user terminal 40.

The server memory 22 stores the procurement management program PG for causing the server control part 23 to execute various processing associated with the selection of the supplying supplier group and the allocation of the request quantity of the article. Incidentally, the procurement management program PG may function as one program in cooperation with the inventory management program. In addition, the server memory 22 stores request information 22A indicating the request condition of the article requested by the user. As an example, the request information 22A includes information for specifying the article requested by the user (for example, the model number of the article) and the request condition (for example, the request quantity and the delivery time) . Then, in the request information 22A, the request condition is associated with user identification information for identifying each user.

The user transmits the request condition via the user terminal 40, and the acquisition part 23A acquires the request condition and stores the request condition in the server memory 22. Alternatively, the administrator of the procurement management server 20 may store the request condition acquired from the user in the server memory 22. In this case, the acquisition part 23A acquires the request condition from the server memory 22. Furthermore, the acquisition part 23A may acquire the request condition stored in an arbitrary storage unit and update the request condition stored by the server memory 22.

Furthermore, the server memory 22 stores order information 22B indicating the contents of the purchase order from the user. As an example, the order information 22B includes information for specifying the article ordered for purchase by the user (for example, the model number of the article), information for specifying the sales order corresponding to the purchase order (for example, the sales order number), and the request quantity of the article. Then, the server memory 22 stores the request quantity in association with the user identification information of each user. In addition, the order information 22B includes information indicating the contents of the sales order and the purchasing order, and information indicating an allocation result by the distribution part 23C. Furthermore, the server memory 22 records various types of data (not illustrated) such as user information, a past quotation result, image data used to display a web page, and data including information such as the model number, name, or feature of the article.

### [Acquisition Unit]

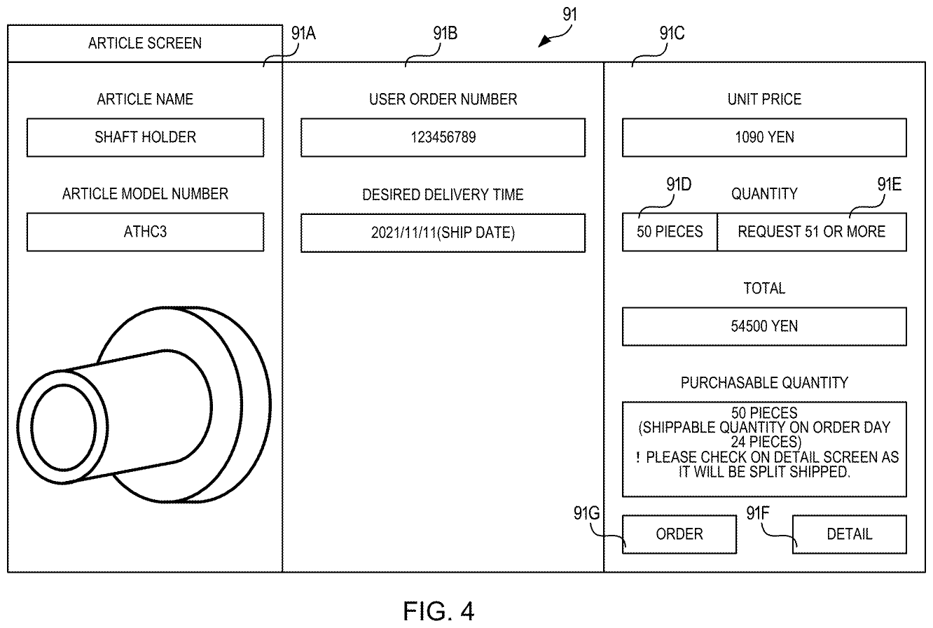

The acquisition part 23A acquires the request condition including the request quantity of the article requested by the user. As an example, the user inputs the request quantity of the article the user wishes to purchase via the web page provided by the server control part 23. Specifically, the server control part 23 authenticates the user through user authentication and the like. Then, the server control part 23 causes the web page to be displayed on the display device (not illustrated) of the user terminal 40. In the web page, the user performs an operation of specifying a desired article, such as selecting a displayed image link or inputting the article model number or article name. Thus, the server control part 23 causes an article screen 91 illustrated in FIG. 4 to be displayed on the display device of the user terminal 40 of the authenticated user. Incidentally, the screen configuration of the article screen 91 can be changed as appropriate, and for example, a delivery time input field 91B and a quantity input field 91C may be combined into one.

In addition, the acquisition part 23A acquires the supply condition including the supply quantity of the article by each of the plurality of suppliers that can supply the article. Specifically, the acquisition part 23A acquires the supply condition from the inventory management memory 12. When the supply condition is updated, the acquisition part 23A acquires the updated supply condition from the inventory management memory 12. For example, the acquisition part 23A requests the inventory management control part 13 to search for the inventory quantity of the requested article. Then, the inventory management control part 13 searches for the inventory quantity of each supplier, and transmits the inventory quantity as the search result to the acquisition part 23A. Incidentally, the supply condition may be stored in the server memory 22 instead of the inventory management memory 12. In this case, the acquisition part 23A reads and acquires the supply condition from the server memory 22.

An article field 91A is provided in the article screen 91 illustrated in FIG. 4, and an article name, article model number, and article image are displayed in the article field 91A. In the example of FIG. 4, “shaft holder” is displayed as the article name, and “ATHC3” is displayed as the article model number. In addition, an image obtained by photographing the shaft holder from the oblique above is displayed as the article image. Incidentally, the article image may be a 3D model of the article.

In addition, the delivery time input field 91B is provided in the article screen 91, and a user order number field for inputting an arbitrary symbol for specifying the purchase order is provided in the delivery time input field 91B. Furthermore, a delivery time field for inputting the delivery time of the article desired by the user is provided in the delivery time input field 91B. When the user inputs the delivery time in the delivery time field, the acquisition part 23A acquires the delivery time input by the user, and includes the delivery time in the request information 22A to be stored in the server memory 22. Incidentally, FIG. 4 illustrates an example in which the delivery time “2021/11/11” based on the ship date is input, and “123456789” is input as the user order number.

Furthermore, the quantity input field 91C is provided in the article screen 91, and a quantity field 91D for inputting the request quantity of the article is provided in the quantity input field 91C. When the user inputs the request quantity in the quantity field 91D, the acquisition part 23A acquires the request quantity input by the user, and includes the request quantity in the request information 22A to be stored in the server memory 22. In addition, when the user wishes to purchase the quantity of articles exceeding the purchasable quantity (51 or more in the example of FIG. 4), the user selects the delivery time check button 91E to request the server control part 23 to check the delivery time. Upon receiving the request, the server control part 23 notifies the user terminal 40 of the available ship date of the quantity of articles exceeding the purchasable quantity and the quantity of articles that can be shipped by the available ship date. Alternatively, upon receiving the request for delivery time check, the server control part 23 may inquire of the supplier about the available ship date of the quantity of articles exceeding the purchasable quantity, and notify the user terminal 40 of the reply.

Alternatively, the user may install application software to the user terminal 40 in advance, and input the request condition such as the desired delivery time and request quantity using the application software. Furthermore, the user may notify the administrator who manages the procurement management server 20 of the request condition by using another means such as telephone or e-mail. In this case, the administrator of the procurement management server 20 inputs the request condition and stores the request condition in the server memory 22. Furthermore, the user may input the request condition on a web page provided by another server. In this case, the acquisition part 23A acquires the request condition from the other server. In addition, the request condition may be included in a form such as a quotation request, purchase order, and inquiry.

In the quantity input field 91C, the unit price of each article, the total monetary amount that is the price of the request quantity of articles, and the purchasable quantity are displayed. In the example of FIG. 4, “1090 yen” is displayed as the unit price, “54500 yen” is displayed as the total monetary amount, and “50” is displayed as the purchasable quantity. Below the purchasable quantity, “24” is displayed as the quantity that can be shipped on the order day. This quantity is a quantity that can be shipped on the order day among the request quantity of articles that can be delivered by the desired delivery time input by the user.

When the request quantity is distributed among the supplying supplier group as described with reference to FIG. 2 as an example, the supply timing of each supplier may be different. For example, FIG. 4 illustrates that the quantity of articles that can be supplied by the supplying supplier group by the desired delivery time is 50, and the supply quantity of articles that can be supplied by the supplier immediately after the order is 24. As an example, the quantity of articles that can be shipped on the order day is a quantity of articles that are already transported by the supplier to the seller and stored in the physical distribution base of the seller.

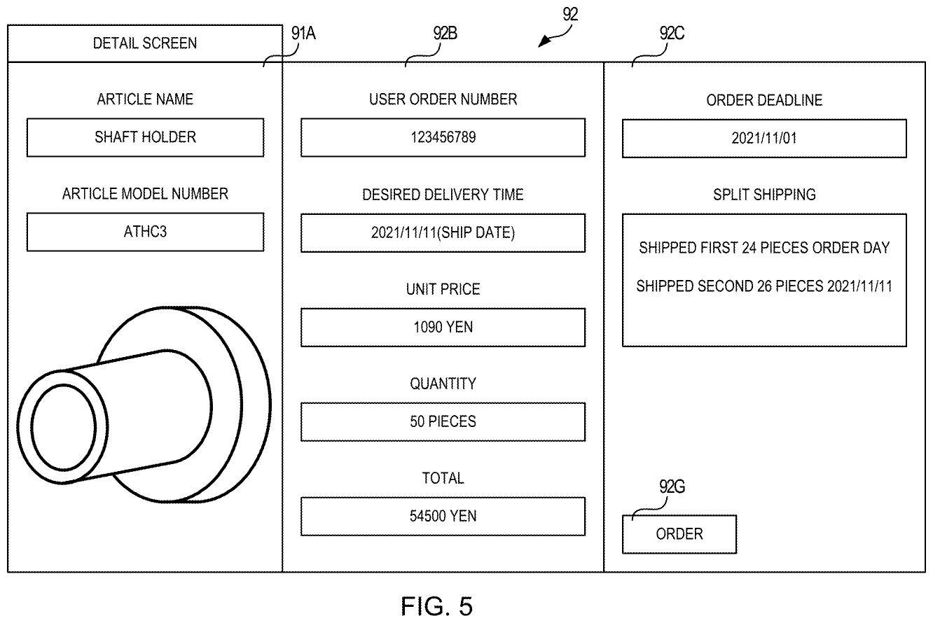

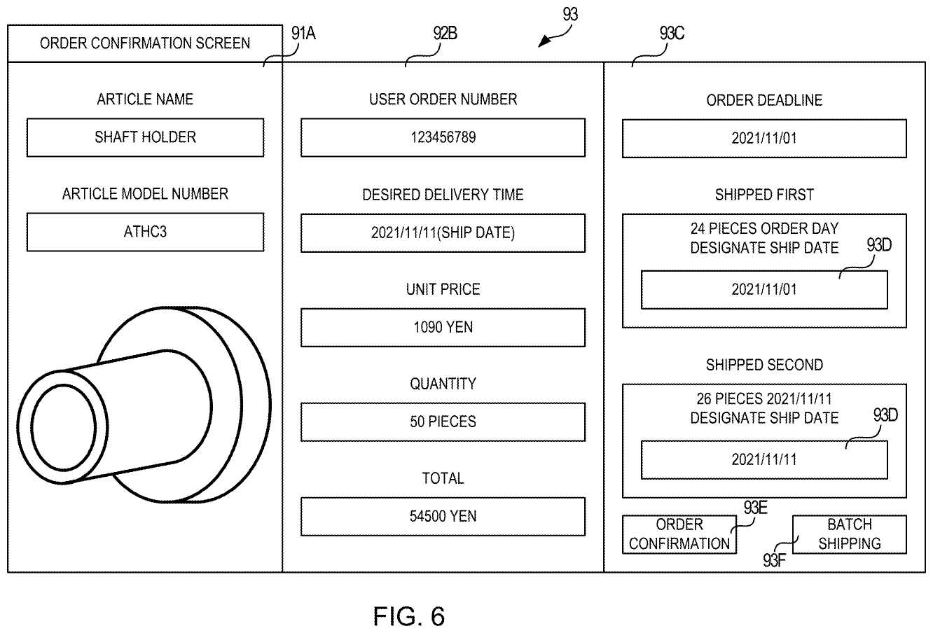

Furthermore, a detail screen button 91F and an order button 91G are provided in the quantity input field 91C. When the user performs an operation of selecting the detail screen button 91F, the server control part 23 causes a detail screen 92 illustrated in FIG. 5 to be displayed on the display device of the user terminal 40. In addition, when the user performs an operation of selecting the order button 91G, the server control part 23 causes an order confirmation screen 93 illustrated in FIG. 6 to be displayed on the display device of the user terminal 40.

### [Presentation Unit]

The presentation part 23H presents to the user split shipping information indicating that the quantity of articles distributed by the distribution part 23C is separately shipped. For example, based on the allocation result by the distribution part 23C, the presentation part 23H presents to the user the quantity of articles distributed by the distribution part 23C and the ship date serving as the supply time of the article, as the split shipping information. Specifically, the presentation part 23H acquires information such as the quantity distributed and the ship date as the allocation result from the distribution part 23C, and presents the information to the user as the split shipping information. Specifically, in the detail screen 92 illustrated in FIG. 5, the quantity of articles to be separately shipped and the ship date are displayed as the split shipping information in a split shipping field 92C. Alternatively, the presentation part 23H may present the split shipping information to the user by notifying the user of the split shipping information by another means such as e-mail. Incidentally, the split shipping information may be a character string (for example, “Shipment is to be made separately”), a symbol, or the like indicating that the shipment is separately made.

In addition, an order deadline is displayed in the split shipping field 92C. The order deadline is the expiration date on which the ship date based on the allocation result by the distribution part 23C and the unit price and total monetary amount serving as a quotation result by the quotation part 23F are valid. When the user confirms the purchase order by the order deadline, the user can purchase the article with the contents indicated by the displayed ship date, unit price, and total monetary amount. Then, after the purchase order is confirmed by the user, the ordering part 23D orders the quantity of articles distributed by the distribution part 23C to each supplier of the supplying supplier group. For this purpose, the ordering part 23D receives the purchase order from the user, and creates the same number of split sales orders as the number of suppliers included in the supplying supplier group based on the purchase order.

In the example of FIG. 5, “2021/11/01” is displayed as the order deadline. In addition, “24 pieces,” which is the number of articles to be shipped first and “the order day, ” which is the ship date for the articles, are displayed. Furthermore, “26 pieces,” which is the number of articles to be shipped second and “2021/11/11,” which is the ship date for the articles, are displayed. Incidentally, as the condition for shipping on the order day, confirming the purchase order by a predetermined time (for example, 12:00) and the like may be set. Furthermore, an order button 92G is provided in the split shipping field 92C. When the user performs an operation of selecting the order button 92G, the server control part 23 causes the order confirmation screen 93 illustrated in FIG. 6 to be displayed on the display device of the user terminal 40.

In addition, the article field 91A and a request condition field 92B are provided in the detail screen 92. The article name, article model number, and article image are displayed in the article field 91A. In addition, the desired delivery time, request quantity, and the like are displayed in the request condition field 92B as the request condition of the article input by the user. Furthermore, the user order number, unit price, and total monetary amount are displayed in the request condition field 92B. Incidentally, the screen configuration of the detail screen 92 can be changed as appropriate.

As illustrated in FIG. 6, the article field 91A, the request condition field 92B, and an order field 93C are provided in the order confirmation screen 93. The article name, article model number, and article image are displayed in the article field 91A. In addition, the desired delivery time, request quantity, and the like are displayed in the request condition field 92B. Furthermore, the order deadline, the number of articles to be separately shipped, and the ship date for the articles are displayed in the order field 93C.

Furthermore, a designation field 93D for designating the ship date is provided in the order field 93C. The user can input the desired ship date in the designation field 93D for each of the first shipment and the second shipment. However, the ship date that can be input by the user is a date after the available ship date. For example, since the first shipment in FIG. 6 can be made on the order day, the user can input the next day of the order day or a date after the next day. In addition, since the second shipment in FIG. 6 can be made on Nov. 11, 2021, the user can input the next day of Nov. 11, 2021 or a date after the next day. An order confirmation button 93E is provided in the order field 93C. When the user performs an operation of selecting the order confirmation button 93E, the ordering part 23D of the server control part 23 receives the purchase order and transmits the purchasing order to the supplier.

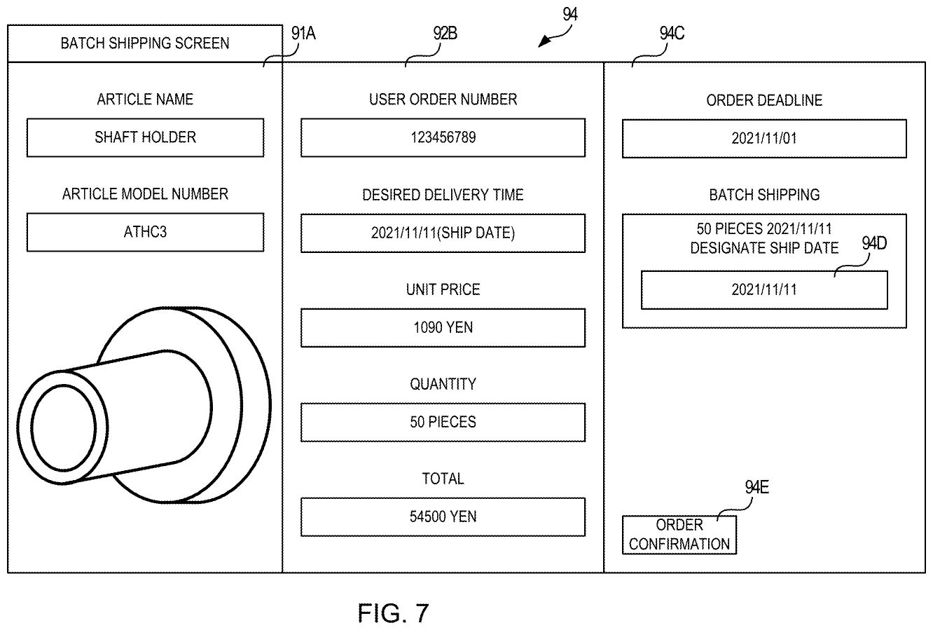

In addition, the presentation part 23H presents batch shipping information indicating that the request quantity of articles are to be collectively shipped to the user. For example, the presentation part 23H presents the quantity of articles to be collectively shipped and the ship date serving as the supply time of the articles to the user as the batch shipping information. Here, the quantity of articles to be collectively shipped coincides with the request quantity. Specifically, a batch shipping button 93F is provided in the order field 93C of the order confirmation screen 93. When the user performs an operation of selecting the batch shipping button 93F, the server control part 23 causes a batch shipping screen 94 illustrated in FIG. 7 to be displayed on the display device of the user terminal 40. A batch shipping field 94C is provided in the batch shipping screen 94. In the batch shipping field 94C, the number of articles to be collectively shipped and the ship date thereof are displayed as the batch shipping information. Alternatively, the presentation part 23H may present the batch shipping information to the user by notifying the user of the batch shipping information by another means such as e-mail.

In addition, the order deadline is displayed in the batch shipping field 94C, and when the user confirms the purchase order by the order deadline, the user can purchase the article with the contents indicated by the displayed ship date, unit price, and total monetary amount. Then, after the purchase order is confirmed by the user, the ordering part 23D orders the quantity of articles distributed by the distribution part 23C to each supplier of the supplying supplier group. For this purpose, the ordering part 23D receives the purchase order from the user, and creates the same number of split sales orders as the number of suppliers included in the supplying supplier group based on the purchase order.

Furthermore, a designation field 94D for designating the ship date is provided in the batch shipping field 94C. The user can input a desired shipping date in the designation field 94D for the articles to be collectively shipped. However, the ship date that can be input by the user is a date after the available ship date. For example, when 24 of 50 articles to be collectively shipped can be shipped on the order day and the remaining 26 articles can be shipped on Nov. 11, 2021, the user can input the next day of Nov. 11, 2021 or a date after the next day. An order confirmation button 94E is provided in the batch shipping field 94C. When the user performs an operation of selecting the order confirmation button 94E, the ordering part 23D receives the purchase order and transmits the purchasing order to the supplier.

As an example of batch shipping of the article, the plurality of suppliers transport the article in the quantity based on the purchasing order received by each supplier to a common accumulation base designated by the purchasing order (for example, the physical distribution base of the seller). For example, it is assumed that the request quantity is 50, the quantity in the purchasing order A received by the supplier A is 24, and the quantity in the purchasing order B received by the supplier B is 26. In this case, the supplier A transports 24 articles to the accumulation base, and the supplier B transports 26 articles to the same accumulation base. Then, a company that manages the accumulation base (for example, the seller) transports 50 articles collectively to the transportation destination designated by the user. Incidentally, the accumulation base may be a physical distribution base of a carrier.

In addition, the article field 91A and the request condition field 92B are provided in the batch shipping screen 94. The article name, article model number, and article image are displayed in the article field 91A. In addition, the desired delivery time, request quantity, and the like are displayed in the request condition field 92B as the request condition of the article input by the user.

### [Determination Unit and Selection Unit]

The determination part 23G determines whether the distribution condition for distributing the request quantity of the article between two or more suppliers among the plurality of suppliers is satisfied, based on the request condition and the supply condition acquired by the acquisition part 23A. As an example, the determination part 23G determines whether the distribution condition is satisfied at the timing when the user inputs the request quantity of the request condition. Alternatively, the determination part 23G may determine whether the distribution condition is satisfied at the timing when the user inputs the request quantity exceeding a reference quantity preset for each article. Then, when the distribution condition is satisfied, the selection part 23B selects two or more suppliers from among the plurality of suppliers as the supplying supplier group. Specifically, when the distribution condition is satisfied, the selection part 23B selects a specific supplier and at least one other supplier different from the specific supplier from among the plurality of suppliers as the supplying supplier group.

As an example, the selection part 23B selects one specific supplier from among the plurality of suppliers. Then, the determination part 23G determines that the distribution condition is satisfied when the request quantity is larger than the supply quantity of the specific supplier. For example, the specific supplier is preset for each article, and the selection part 23B selects the specific supplier set for the article included in the request condition. Then, when the determination part 23G determines that the distribution condition is satisfied, the selection part 23B further selects at least one other supplier different from the specific supplier. For example, based on the supply time in the supply condition, the selection part 23B selects two or more suppliers that can supply the article by the delivery time in the request condition from among the plurality of suppliers, as the supplying supplier group. In this manner, the selection part 23B selects the supplying supplier group including the specific supplier and another supplier. As a result, the quantity exceeding the supply quantity of the specific supplier of the request quantity of the article can be distributed to the other supplier.

In addition, by referring to the delivery time in the request condition and the supply time in the supply condition, the selection part 23B searches for a supplier that can supply (for example, can ship) the article by the delivery time. For example, it is assumed that, when the delivery time is November 3 and the request quantity is 50, the ship date of the supplier A is November 2 and the supply quantity is 24, the ship date of the supplier B is November 3 and the supply quantity is 26, and the ship date of the supplier C is November 4 and the supply quantity is 50. At this time, since the ship date of the supplier C is later than the delivery time, the selection part 23B selects the supplier A and the supplier B as the supplying supplier group. Incidentally, if the selection part 23B cannot find the supplier that can supply the article by the delivery time, the server control part 23 notifies the user terminal 40 of the available ship date of the article and the quantity of articles that can be shipped by the available ship date, as it does when the user orders the quantity exceeding the purchasable quantity. The user checks and corrects the delivery time and performs the operation of the purchase order described above.

For example, the selection part 23B searches for a supplier having the largest supply quantity of articles that can be supplied by the delivery time in the request condition, and selects the supplier as the other supplier. In addition, based on the supply time in the supply condition, the selection part 23B may search for a supplier having the shortest supply time of the article that can be supplied by the delivery time in the request condition, and select the supplier as the other supplier. Alternatively, the selection part 23B may select a supplier having the largest supply quantity of the article indicated by a prediction result of the prediction part 23E to be described later as the other supplier. In addition, the selection part 23B may select a supplier having the shortest supply time of the article indicated by the prediction result of the prediction part 23E as the other supplier.

In addition, based on the supply time, the selection part 23B may select a supplier that can supply the article by the delivery time and has the largest supply quantity from among the plurality of suppliers, as the specific supplier. In this case, the selection part 23B refers to the supply condition, searches for a supplier that can supply the largest quantity of articles, and selects the supplier as the specific supplier. For example, the selection part 23B selects a supplier having a large inventory quantity as the specific supplier so that the supplier whose inventory quantity serving as the supply quantity is large preferentially supplies the article. Furthermore, the selection part 23B selects a supplier having the second largest supply quantity after the specific supplier as the other supplier.

Furthermore, based on the supply time, the selection part 23B may select a supplier that can supply the article by the delivery time and has the earliest or shortest supply time from among the plurality of suppliers, as the specific supplier. In this case, the selection part 23B refers to the supply condition, searches for a supplier that has the earliest or shortest supply time, and selects the supplier as the specific supplier. Furthermore, the selection part 23B selects a supplier having the second earliest or shortest supply time after the specific supplier as the other supplier. As a result, a supplier that can supply the article to the user earlier is included in the supplying supplier group. Incidentally, the selection part 23B may select the supplying supplier group based on the cost such as the unit price or the transportation cost in the supply condition. Incidentally, the cost may include other costs such as a raw material cost, processing cost, production cost, tax such as a tariff, storage cost, export cost, and import cost.

As another example, the determination part 23G determines that the distribution condition is satisfied when the request quantity is larger than the predicted supply quantity that is obtained by subtracting the predicted purchase quantity serving as the prediction result predicted by the prediction part 23E from the supply quantity of the specific supplier. For example, a purchase order to the specific supplier by another user may be predicted in a period around the desired delivery time. In this case, the inventory quantity of the specific supplier is prevented from becoming zero by subtracting the predicted purchase quantity by another user. As a result, a delay in the delivery for the purchase order by another user, which occurs when the inventory quantity of the specific supplier becomes zero, can be prevented by subtracting the predicted purchase quantity.

Alternatively, the determination part 23G may determine that the distribution condition is satisfied when the request quantity is larger than the reference quantity preset for each article.

Furthermore, as another example, the determination part 23G determines that the distribution condition is satisfied when the request quantity is larger than the predicted supply quantity that is obtained by adding the predicted increased quantity serving as the prediction result predicted by the prediction part 23E to be described later to the supply quantity of the specific supplier. For example, an increase in the supply quantity may be predicted before the supply condition is updated. In this case, even when the supply quantity of the specific supplier at the time of selection is smaller than the request quantity, the determination part 23G adds the predicted increased quantity in anticipation of the increase in the inventory quantity of the specific supplier. As a result, the quantity exceeding the supply quantity of the specific supplier of the request quantity can be distributed to the other supplier in consideration of the predicted increased quantity.

### [Distribution Unit]

The distribution part 23C distributes the request quantity in the request condition among the supplying supplier group selected by the selection part 23B. As an example, the distribution part 23C distributes the quantity corresponding to the supply quantity of the specific supplier of the request quantity to the specific supplier. Then, the distribution part 23C distributes the remaining quantity of the request quantity to the other supplier of the supplying supplier group. For example, when the request quantity is 50 and the supply quantity of the specific supplier A is 24, the distribution part 23C distributes the remaining 26 pieces to the other supplier B. As a result, even when the request quantity of the article is larger than the supply quantity of the specific supplier, the article can be supplied to the user by the selected supplying supplier group. In addition, when the user places a purchase order for a large quantity of articles by electronic commerce, the request quantity can be dynamically distributed to each of the plurality of suppliers constituting the supplying supplier group. Therefore, the inventory quantity of the suppliers can be reduced, and the article can be shipped in a short period of time.

As another example, the distribution part 23C may allocate the same number of articles among the request quantity to the suppliers selected for the supplying supplier group. For example, when the request quantity is 50, the distribution part 23C distributes 25 pieces to the specific supplier A and the remaining 25 pieces to the other supplier B. In addition, the distribution part 23C may allocate the largest quantity of the request quantity to the specific supplier. For example, when the request quantity is 50, the distribution part 23C distributes 26 pieces to the specific supplier A and the remaining 24 pieces to the other supplier B.

Furthermore, to average the inventory quantity, the distribution part 23C may divide the request quantity such that the value of the variance of the inventory quantity is smaller. For example, it is assumed that the inventory quantity of the specific supplier A is 30, the inventory quantity of the other supplier B is 20, the inventory quantity of the other supplier C is 15, and the request quantity is 50. In this case, the distribution part 23C distributes 25 pieces to the specific supplier A, 15 pieces to the other supplier B, and 10 pieces to the other supplier C. As a result, the inventory quantity of each of the specific supplier A, the other supplier B, and the other supplier C is five, and there is no variance in inventory quantity.

Furthermore, the distribution part 23C may divide the request quantity based on a plurality of conditions. As an example, the distribution part 23C distributes the same number among the other suppliers from the quantity exceeding the supply quantity that can be supplied by the specific supplier. For example, when the request quantity is 50 and the supply quantity of the specific supplier A is 24, the distribution part 23C distributes 13 of the remaining 26 pieces to the other supplier B and distributes the remaining 13 pieces to the other supplier C.

### [Ordering Unit]

The ordering part 23D orders the quantity of articles distributed by the distribution part 23C to the supplying supplier group. For example, the user checks the contents of the quotation and confirms the purchase order (selects the order confirmation button 93E in FIG. 6). Then, the ordering part 23D that has received the confirmation of the purchase order orders the article to the suppliers included in the supplying supplier group. Therefore, the presentation part 23H presents the quantity of articles distributed by the distribution part 23C and the ship date serving as the supply time of the articles to the user. As an example, the presentation part 23H presents the split shipping information to the user by displaying the ship date and the quantity of articles on the detail screen 92 in FIG. 5.

In the example of FIG. 2, the ordering part 23D that has received the confirmation of the purchase order creates the same number of split sales orders as the number of suppliers included in the supplying supplier group based on the purchase order from the user. Specifically, the ordering part 23D creates the split sales order A and the split sales order B corresponding to the supplier A and the supplier B, respectively. In addition, the ordering part 23D includes information specifying the article, information indicating the allocated quantity of articles, and the like in the split sales order. Incidentally, the information is associated with the split sales order identification information, and is included in the order information 22B to be stored by the server memory 22.

Furthermore, the ordering part 23D transmits the purchasing order corresponding to the split sales order to each supplier, and orders the article. In the example of FIG. 2, the ordering part 23D transmits the purchasing order A corresponding to the split sales order A to the supplier A, and transmits the purchasing order B corresponding to the split sales order B to the supplier B. In addition, the ordering part 23D includes the information specifying the article, information indicating the quantity of articles to be supplied, information indicating the delivery time of the article, transportation destination of the article, and the like in the purchasing order. Incidentally, the information is associated with the purchasing order identification information for identifying the purchasing order, and is included in the order information 22B to be stored by the server memory 22.

Then, the supplier that has received the purchasing order ships the article on or before the delivery time and transports the article to the user. As an example of shipment of the article, each of the plurality of suppliers transports the quantity of articles based on the received purchasing order to the transportation destination designated by the user. For example, it is assumed that the request quantity is 50, the quantity in the purchasing order A received by the supplier A is 24, and the quantity in the purchasing order B received by the supplier B is 26. In this case, the supplier A transports 24 articles to the transportation destination, and the supplier B transports 26 articles to the transportation destination. In this manner, since the ordering part 23D creates the split sales order, the user can omit the operation of placing the purchase order to the plurality of suppliers. Incidentally, the ordering part 23D may create the split sales order simultaneously with the creation of the quotation result by the quotation part 23F.

Furthermore, if an inhibiting condition that inhibits the supply of the article occurs in at least one supplier of the supplying supplier group, the ordering part 23D may order the quantity of articles distributed to the supplier in which the inhibiting condition occurs to the supplier that can supply the article among the plurality of suppliers. For example, an unexpected delivery delay may occur at the supplier between the transmission of the purchasing order to the ship date. In this case, the ordering part 23D refers to the supply condition stored by the inventory management memory 12 and searches for a supplier that can supply the article by the delivery time from among the plurality of suppliers. Alternatively, the ordering part 23D searches for a supplier that can supply the article earliest from among the plurality of suppliers. Then, the ordering part 23D transmits the purchasing order to the supplier to order the quantity of articles distributed to the supplier in which the inhibiting condition occurs.

As an example, the ordering part 23D determines that the inhibiting condition has occurred upon receiving a notification that the delivery is delayed or becomes impossible from the supplier. Alternatively, the ordering part 23D determines that the inhibiting condition has occurred when the article has not been supplied by the delivery time, for example, when a shipping notification of the article has not been received from the supplier by the delivery time. In addition, the ordering part 23D may determine that the inhibiting condition has occurred when the occurrence of a natural disaster, a disaster, a transport disorder, and the like has been detected.

### [Prediction Unit]

The prediction part 23E predicts a demand for the article in a predetermined period. In this case, the selection part 23B selects the supplying supplier group based on the prediction result by the prediction part 23E such that a variation in the inventory quantity among the plurality of suppliers in the predetermined period is smaller. As an example, the prediction part 23E predicts the purchase quantity of the article in the predetermined period (for example, one week), and outputs the predicted purchase quantity to the selection part 23B as the prediction result. The selection part 23B selects the supplying supplier group based on the predicted purchase quantity and the inventory quantity acquired by the acquisition part 23A such that the variation in the inventory quantity is smaller. As a result, the supplier can be selected so as to minimize the variation in the inventory quantity during the predetermined period for which the demand is predicted, thus averaging the inventory quantity among the suppliers.

For example, it is assumed that the inventory quantity of the specific supplier A is 30, the inventory quantity of the other supplier B is 20, the request quantity is 25, and the predicted purchase quantity in one week is 30. In this case, the inventory quantity of the specific supplier A is larger than the request quantity, but when only the specific supplier A is selected, the difference in the inventory quantity between the specific supplier A and the other supplier B is 15 in one week, causing a variation. Then, the selection part 23B selects the specific supplier A and the other supplier B as the supplying supplier group to allow the article to be distributed to the other supplier B. In this case, the distribution part 23C may distribute 17 pieces to the specific supplier A and distribute 8 pieces to the other supplier B so that the variation in the inventory quantity among the plurality of suppliers in the predetermined period is smaller.

As an example, the prediction part 23E predicts the predicted increased quantity of the supply quantity, the predicted supply quantity, the predicted supply time, the predicted purchase quantity, or the like as the demand for the article. For example, the prediction part 23E predicts the current demand for the article based on the past supply quantity or purchase quantity in the same period. Specifically, the prediction part 23E outputs the prediction result using the past supply quantity or purchase quantity as the current supply quantity or purchase quantity in the same period. Alternatively, the prediction part 23E may predict the demand for the article using a learning model constructed based on learning data including actual data such as the past supply quantity or purchase quantity. Incidentally, the learning model may be constructed by the inventory management server 10 or the procurement management server 20, or may be a learning model constructed in advance.

### [Quotation Unit]

The quotation part 23F notifies the user of the unit price of the article and the total monetary amount of the request quantity of articles as the quotation result. Specifically, the quotation part 23F notifies the user by displaying the unit price and the total monetary amount on the detail screen 92 illustrated in FIG. 5. For example, the quotation part 23F creates the quotation result by referring to the supply condition (for example, the unit price of the article) acquired by the acquisition part 23A. Incidentally, the quotation result may include the ship date, the number of actual work days required until shipping, and the like.

### [Terminal]

The user terminal 40 includes a user terminal control part 45 that controls the user terminal 40 and a user terminal memory 44 that stores a control program. The user terminal control part 45 is a computer in which a processor that executes various arithmetic processes and operation control according to a predetermined program and other peripheral devices are combined. The user terminal 40 further includes a display device and an input device (not illustrated). Incidentally, the input device (not illustrated) is a device such as a keyboard, a numeric keypad, and a touch panel, and the user inputs the request quantity and the like by using the input device. In addition, the display device (not illustrated) displays a web page such as the screens, and the user places the purchase order of the article according to the displayed web page.

The supplier terminal 60 includes a supplier terminal control part 65 that controls the supplier terminal 60 and a supplier terminal memory 64 that stores a control program. The supplier terminal control part 65 is a computer in which a processor that executes various arithmetic processes and operation control according to a predetermined program and other peripheral devices are combined. In addition, the supplier terminal 60 further includes a display device and an input device (not illustrated) . The supplier inputs the supply quantity and the like using the input device.

As an example, the processors of the user terminal control part 45 and the supplier terminal control part 65 are, for example, a CPU or an MPU, and control the entire terminal based on the control program stored in the user terminal memory 44 and the supplier terminal memory 64, and also control various processes in an integrated manner. The user terminal memory 44 and the supplier terminal memory 64 further include a RAM that is a system work memory for the processor to operate, and a storage device such as a ROM, an HDD, and an SSD that store a program and system software. Incidentally, the user terminal control part 45 and the supplier terminal control part 65 can also perform control according to a program stored in a portable recording medium such as a CD, a DVD, a CF card, and a USB memory, or an external storage medium such as a cloud server on the Internet. In addition, the user terminal memory 44 and the supplier terminal memory 64 are an external storage device including a non-volatile storage medium (non-transitory computer-readable storage medium) such as a hard disk and a semiconductor storage device.

### [Distribution Processing]

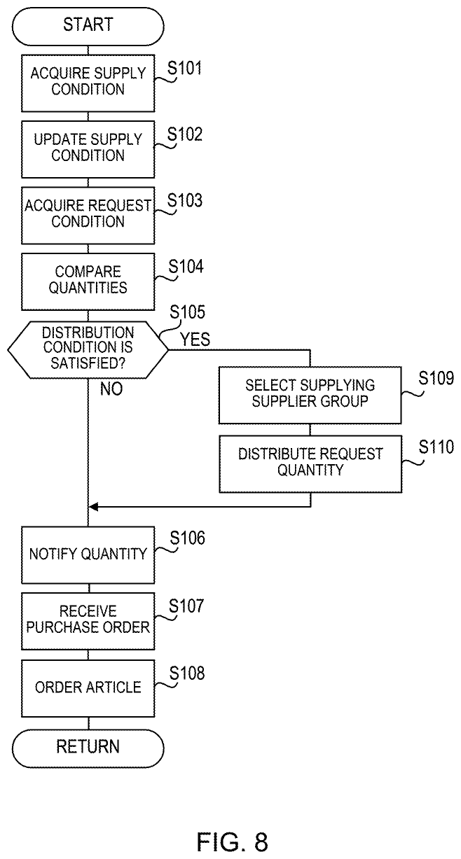

Distribution processing in the procurement management system will be described with reference to FIG. 8. When the supplier transmits the supply condition including the supply quantity to the inventory management server 10, the update part 13A acquires the supply condition (S101). Then, the update part 13A updates the supply condition stored by the inventory management memory 12 to the latest supply condition based on the acquired supply condition (S102). Alternatively, when the transmission of the supply condition is the first one, the update part 13A stores the acquired supply condition in the inventory management memory 12. In addition, the user inputs the request condition including the request quantity of the article the user wishes to purchase via the web page provided by the server control part 23. Then, the acquisition part 23A acquires the request condition input by the user (S103). In addition, the acquisition part 23A acquires the supply quantity from the inventory management server 10.

The determination part 23G compares the request quantity acquired by the acquisition part 23A with the supply quantity (S104), and determines whether the distribution condition is satisfied (S105). At this time, the determination part 23G determines that the distribution condition is not satisfied when the request quantity is smaller than the supply quantity of the specific supplier (NO in S105). That is, the determination part 23G determines that the specific supplier can supply the article alone. In this case, since the request quantity is not distributed, the quotation part 23F notifies the user of the same quantity as the request quantity as the purchasable quantity (S106). For example, the quotation part 23F displays the quantity and the ship date of the article on the display device of the user terminal 40. Then, the user checks the quantity and performs the operation of confirming the purchase order, and the ordering part 23D receives the purchase order (S107). Subsequently, the ordering part 23D transmits the purchasing order to the specific supplier to order the article (S108).

On the other hand, when the request quantity is larger than the supply quantity of the specific supplier, the determination part 23G determines that the distribution condition is satisfied (YES in S105). Then, the selection part 23B selects the specific supplier and the other supplier that can supply the article by the delivery time in the request condition as the supplying supplier group (S109). In addition, the distribution part 23C distributes the request quantity in the request condition among the supplying supplier group selected by the selection part 23B (S110). Subsequently, the quotation part 23F notifies the user of the distributed quantity (S106). For example, the quotation part 23F causes the distributed quantity and the ship date of the article to be displayed on the display device of the user terminal 40. Then, the user checks the quantity and performs the operation of confirming the purchase order, and the ordering part 23D receives the purchase order (S107). Subsequently, the ordering part 23D transmits the purchasing order to each supplier of the supplying supplier group to order the article (S108). This ends the distribution processing.

According to the procurement management system according to the first embodiment described above, the period from the purchase order to the delivery of the article can be shortened by distributing the quantity of the article requested by the user among the plurality of sub-suppliers. That is, the quantity exceeding the supply quantity of the request quantity can be ordered to another supplier and the article can be delivered earlier. In addition, when placing the purchase order of a large quantity of articles, the user does not need to calculate the quantity for the purchase order to each of the plurality of suppliers. The user also does not need to place the purchase order to each of the plurality of suppliers. Therefore, the calculation and operation at the time of the purchase order can be omitted and the time required for the purchase order can be shortened. Furthermore, since the supply quantity of each supplier is dynamically updated, the necessity of distributing the request quantity is determined based on a newer supply quantity.

Incidentally, the control method of the above-described procurement management system is executed by the inventory management control part 13 and the server control part 23 serving as computers in cooperation with each other. Specifically, the control method includes an acquisition step, a determination step, a selection step, and a distribution step. In the acquisition step, the request condition including the request quantity of the article requested by the user and the supply condition including the supply quantity of the article by each of the plurality of suppliers that can supply the article are acquired. In addition, in the determination step, it is determined whether the distribution condition for distributing the request quantity of the article between two or more suppliers among the plurality of suppliers is satisfied, based on the request condition and the supply condition. Furthermore, in the selection step, when the distribution condition is satisfied, two or more suppliers are selected from among the plurality of suppliers as the supplying supplier group. Then, in the distribution step, the request quantity is distributed among the supplying supplier group. Alternatively, one of the inventory management control part 13 and the server control part 23 may execute the acquisition step, the determination step, the selection step, and the distribution step.

### [Second Embodiment]

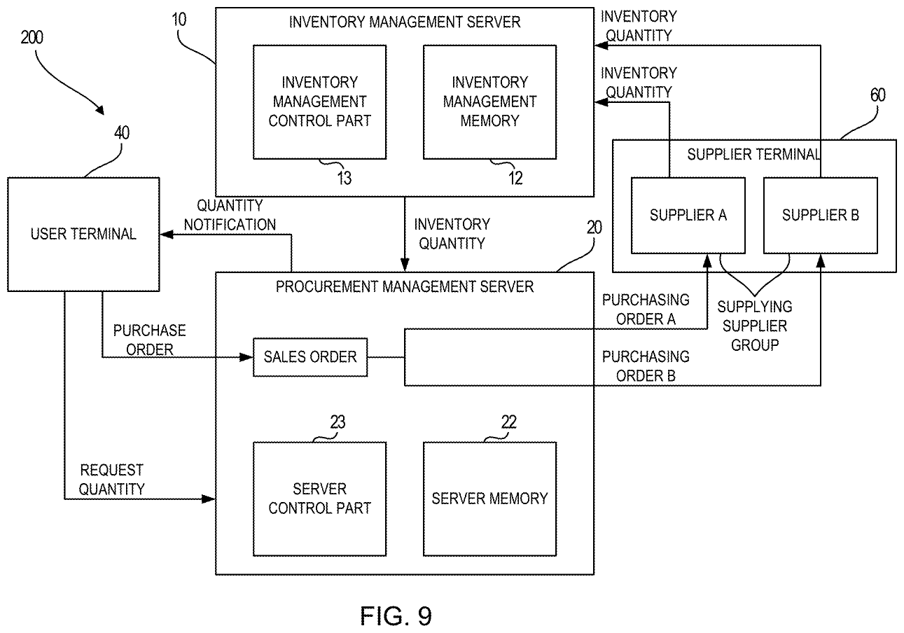

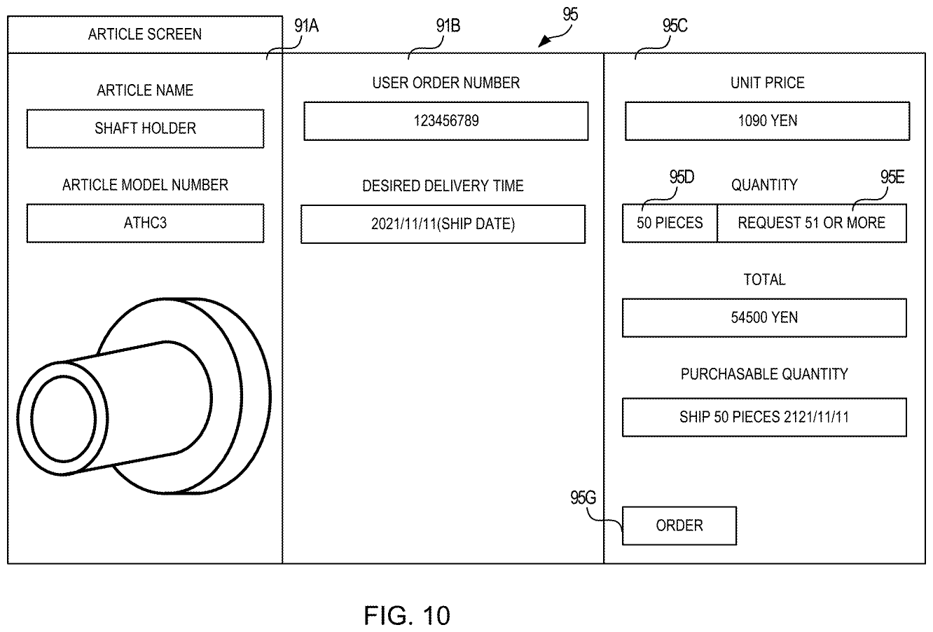

A second embodiment will be described with reference to FIGS. 9 and 10. A procurement management system included in a sales management system 200 of the second embodiment is different from that of the first embodiment in that a plurality of purchasing orders are created without creating a plurality of sales orders. Incidentally, in the description of the second embodiment, differences from the first embodiment will be described. The already described components are denoted by the same reference signs, and the description thereof will be omitted. Unless otherwise described, the components denoted by the same reference signs exhibit substantially the same operation and function, and the functions and effects thereof are also substantially the same.

Procurement management by the procurement management system of the second embodiment will be described with reference to FIG. 9. The supplier terminal 60 includes the terminal of the supplier A and the terminal of the supplier B. Each of the supplier terminals 60 transmits the supply condition including the inventory quantity to the inventory management server 10 at an arbitrary timing. Then, the inventory management control part 13 of the inventory management server 10 stores the received supply condition in the inventory management memory 12 in association with each supplier identification information for each article.

The user who wishes to purchase the article accesses the website provided by the procurement management server 20 from the user terminal 40. Specifically, the server control part 23 of the procurement management server 20 causes an article screen 95 as illustrated in FIG. 10 to be displayed on the display device of the user terminal 40.

The article field 91A and the delivery time input field 91B are provided in the article screen 95. In addition, a quantity input field 95C is provided in the article screen 95, and a quantity field 95D for inputting the request quantity of the article is provided in the quantity input field 95C. When the user inputs the request quantity in the quantity field 95D, the server control part 23 acquires the request quantity input by the user, and includes the request quantity in the request information 22A to be stored in the server memory 22. In addition, when the user wishes to purchase the quantity of articles exceeding the purchasable quantity, the user selects a delivery time check button 95E to request for delivery time check.

The user inputs the request quantity and the delivery time of the article via the article screen 95. The server control part 23 of the procurement management server 20 acquires the input request condition and stores the acquired request condition in the server memory 22 of the procurement management server 20. Then, the server control part 23 acquires the inventory quantity from the inventory management server 10 and selects the specific supplier that can supply the requested article. Here, when the inventory quantity of the specific supplier is equal to or larger than the request quantity, the server control part 23 selects the specific supplier. Then, the server control part 23 notifies the user that the purchase order is possible, and the user performs the operation of transmitting the purchase order. For this purpose, an order button 95G is provided in the article screen 95 illustrated in FIG. 10. When the user performs an operation of selecting the order button 95G, the server control part 23 causes the order confirmation screen (not illustrated) to be displayed on the display device of the user terminal 40. Then, the user checks the contents of the purchase order on the order confirmation screen, and selects the order confirmation button to place the purchase order. Incidentally, since the article screen 95 supports batch delivery, the detail screen button 91F is not provided.

On the other hand, when the inventory quantity of the specific supplier is smaller than the request quantity, the server control part 23 selects the specific supplier and the other supplier that can supply the article from among the plurality of suppliers as the supplying supplier group. At this time, the server control part 23 selects the supplying supplier group such that the total inventory quantity of the supplying supplier group is equal to or larger than the request quantity. Then, the server control part 23 distributes the request quantity of the article among the supplying supplier group.

Furthermore, the server control part 23 notifies the user that the purchase order is possible by presenting the purchasable quantity of the article to the user as the batch shipping information. In addition, when the user performs the operation of selecting the order button 95G (FIG. 10), the server control part 23 causes the order confirmation screen (not illustrated) to be displayed on the display device of the user terminal 40. Then, the user checks the contents of the purchase order on the order confirmation screen, and selects the order confirmation button to place the purchase order. Subsequently, the server control part 23 receives the purchase order, and creates a plurality of purchasing orders associated with basic sales identification information for identifying the sales order corresponding to the received purchase order. The plurality of purchasing orders are associated with the basic sales identification information for identifying each purchasing order.

In the example of FIG. 9, the server control part 23 creates the purchasing order A and the purchasing order B corresponding to one sales order as the plurality of purchasing orders. The purchasing order A is an order to the supplier A, and the purchasing order B is an order to the supplier B. Then, the server control part 23 transmits the plurality of purchasing orders to the supplier terminal 60 of each supplier. Thereafter, each supplier supplies the article corresponding to the purchasing order. For example, the supplier ships the article specified by the model number to the common accumulation base specified by the purchasing order in the quantity and the shipping timing specified by the purchasing order. In this case, the supplier A and the supplier B transport the allocated quantity of articles to the accumulation base. Then, the company that manages the accumulation base (for example, the seller) transports the accumulated articles collectively to the transportation destination designated by the user.

According to the procurement management system according to the second embodiment described above, the period from the purchase order to the delivery of the article can be shortened by distributing the quantity of the article requested by the user among the plurality of sub-suppliers. In addition, when placing the purchase order of a large quantity of articles, the user does not need to calculate the quantity for the purchase order to each of the plurality of suppliers. The user also does not need to place the purchase order to each of the plurality of suppliers. Therefore, the calculation and operation at the time of the purchase order can be omitted and the time required for the purchase order can be shortened.

Furthermore, since the supply quantity of each supplier is dynamically updated, the necessity of distributing the request quantity is determined based on a newer supply quantity.

Hitherto, the present invention has been described with reference to each embodiment, but the present invention is not limited to the above embodiments. Inventions modified within a range without contradictory to the present invention and inventions equivalent to the present invention are also included in the present invention. In addition, each embodiment and each modification can be appropriately combined within a range without contradictory to the present invention.

For example, the inventory management server 10 and the procurement management server 20 may be one server. In addition, each logical device provided in the inventory management server 10 may be provided in the procurement management server 20. Furthermore, each logical device provided in the procurement management server 20 may be provided in the inventory management server 10. In addition, each logical device provided in the inventory management server 10 and the procurement management server 20 may be provided in another server. In this case, the another server, the inventory management server 10, and the procurement management server 20 cooperate to constitute the procurement management system.

10: procurement management system (inventory management server)

12: inventory management memory (storage unit)

13A: update part (update unit)

20: procurement management system (procurement management server)

23: server control part (computer)

23A: acquisition part (acquisition unit)

23B: selection part (selection unit)

23C: distribution part (distribution unit)

23D: ordering part (ordering unit)

23E: prediction part (prediction unit)

23G: determination part (determination unit)

23H: presentation part (presentation unit)

PG: procurement management program (computer program)

1. A procurement management system comprising:
a processor, wherein
the processor is configured to:
update periodically or in real time a supply condition of each supplier stored by a storage medium;
acquire a request condition including a request quantity of an article which is requested by a user from a user terminal in response to input to the user terminal by the user;
determine, following acquisition of the request condition from the user terminal, whether or not a distribution condition for distributing the request quantity of the article between two or more suppliers among a plurality of suppliers is satisfied based on the request condition and a latest supply condition which is stored by the storage medium and which is the supply condition including a supply quantity and a supply time of the article by each of the plurality of suppliers that can supply the article;
allocate the request quantity to one supplier of the plurality of suppliers based on the latest supply condition, when determining that the distribution condition is not satisfied, and cause the supply time of the article by the one supplier to be displayed on the user terminal; and
select two or more suppliers from the plurality of suppliers as a supplying supplier group based on the latest supply condition, when determining that the distribution condition is satisfied, distribute the request quantity among the supplying supplier group, and cause the supply time of the article by the supplying supplier group to be displayed on the user terminal.

12. (canceled)

13. The procurement management system according to claim 1, wherein the processor is configured to cause split shipping information to be displayed on the user terminal when determining that the distribution condition is satisfied, the split shipping information indicates that the request quantity of articles is separately shipped, and the split shipping information includes a quantity and the supply time of the article which are divided by each shipment.

14. The procurement management system according to claim 1, wherein the processor is configured to cause batch shipping information to be displayed on the user terminal when determining that the distribution condition is satisfied, the batch shipping information indicates that the request quantity of articles are to be collectively shipped, and the batch shipping information includes the supply time for collectively shipping the request quantity of articles.

15. The procurement management system according to claim 1, wherein the processor is configured to cause purchasable quantity to be displayed in an input screen for the request condition of the article on the user terminal, and the purchasable quantity is a capable quantity to be supplied by the plurality of suppliers.

16. A computer program of a procurement management system comprising a processor, the computer program causing the processor to:
update periodically or in real time a supply condition of each supplier stored by a storage medium;
acquire a request condition including a request quantity of an article which is requested by a user from a user terminal in response to input to the user terminal by the user;
determine, following acquisition of the request condition from the user terminal, whether or not a distribution condition for distributing the request quantity of the article between two or more suppliers among a plurality of suppliers is satisfied based on the request condition and a latest supply condition which is stored by the storage medium and which is the supply condition including a supply quantity and a supply time of the article by each of the plurality of suppliers that can supply the article;
allocate the request quantity to one supplier of the plurality of suppliers based on the latest supply condition, when determining that the distribution condition is not satisfied, and cause the supply time of the article by the one supplier to be displayed on the user terminal; and
select two or more suppliers from the plurality of suppliers as a supplying supplier group based on the latest supply condition, when determining that the distribution condition is satisfied, distribute the request quantity among the supplying supplier group, and cause the supply time of the article by the supplying supplier group to be displayed on the user terminal.

17. A control method of a procurement management system having a processor, the control method comprising causing the processor to:
update periodically or in real time a supply condition of each supplier stored by a storage medium;
acquire a request condition including a request quantity of an article which is requested by a user from a user terminal in response to input to the user terminal by the user;
determine, following acquisition of the request condition from the user terminal, whether or not a distribution condition for distributing the request quantity of the article between two or more suppliers among a plurality of suppliers is satisfied based on the request condition and a latest supply condition which is stored by the storage medium and which is the supply condition including a supply quantity and a supply time of the article by each of the plurality of suppliers that can supply the article;
allocate the request quantity to one supplier of the plurality of suppliers based on the latest supply condition, when determining that the distribution condition is not satisfied, and cause the supply time of the article by the one supplier to be displayed on the user terminal; and
select two or more suppliers from the plurality of suppliers as a supplying supplier group based on the latest supply condition, when determining that the distribution condition is satisfied, distribute the request quantity among the supplying supplier group, and cause the supply time of the article by the supplying supplier group to be displayed on the user terminal.
